(19) United States
(12) Patent Application Publication
(10) Pub. No.: US 2015/0001365 A1
(43) Pub. Date: Jan. 1, 2015

(54) TRIPOD HEAD

(71) Applicant: Philippe VOGT, Bussieres (FR)

(72) Inventor: Philippe Vogt, Bussieres (FR)

(21) Appl. No.: 14/376,564

(22) PCT Filed: Feb. 5, 2013
(86) PCT No.: PCT/EP2013/052228

§ 371 Date: Aug. 4, 2014

(30) Foreign Application Priority Data
Feb. 8, 2012 (DE) 10 2012 101 007.2

(51) Int. Cl. F16M 11/14; F16M 11/10

(52) U.S. Cl. CPC F16M 11/14; F16M 11/10
USPC 248/371

(57) ABSTRACT

A tripod head for receiving an optical device, comprising a cylinder-shaped housing having a connection device for a tripod at one end, and comprising a plane-symmetrical body arranged such that it can pivot in the housing, and comprising a locking device for clamping the plane-symmetrical body, wherein the plane-symmetrical body is a hollow and two-piece joint ball, the cavity of which forms an installation space and a guide for a pivoting part.

### CROSS REFERENCE TO RELATED APPLICATION

The present application claims the priority benefits of International Patent Application No. PCT/EP2013/052228, filed on Feb. 5, 2013, and claims benefit of DE 10 2012 101 007.2, filed on Feb. 8, 2012.

### BACKGROUND OF THE INVENTION

The invention relates to a tripod head for receiving an optical device, comprising a cylinder-shaped housing which comprises a connection device for a tripod at one end, and comprising a plane-symmetrical body arranged such that it can pivot in the housing, and comprising a locking device for clamping the plane-symmetrical body.

EP 1 473 510 A1 discloses a tripod head containing a cylindrical housing which comprises a connection means for a tripod at one end. It contains a joint ball which is mounted such that it can rotate and pivot in the housing, a receiving part for the joint ball and a device for locking the joint ball having at least one locking member and an adjusting screw, which device presses the joint ball against the housing in order to achieve a clamping effect. The receiving part is a bearing element having a sliding surface which lies against the circumference of the joint ball and is arranged such that it can be axially displaced and rotated in the housing. The device for locking the joint ball comprises an abutment for the bearing element and means which are operatively connected to the abutment in order to displace the bearing element against the joint ball in order to achieve the clamping effect.

This type of tripod head has proven to be successful by reason of the reliable and precise adjustability and makes it possible to absorb or retain large forces or a heavy camera etc.

However, there are situations in which further adjustment options are desired, wherein a basic setting is retained.

In contrast, EP 0 349 948 A1 discloses a tripod head for receiving an optical device comprising a cylinder-shaped housing which comprises a connection device for a tripod at one end, and is formed having a plane-symmetrical body, which is arranged so as to be movable in the housing, and having a locking device for clamping the body. The locking device comprises at least two members which are each provided with an inclined surface which are supported on a positionally fixed base and are arranged with the inclined surfaces lying one on top of the other and such that they can be displaced transversely with respect to one another in order to displace one of the members against the body in order to achieve the clamping effect. An adjusting device which is in engagement with the other member in order to displace the other member transversely with respect to the first-mentioned member is likewise present.

In accordance with one embodiment, the first and second bodies are arranged at a right angle with respect to one another and in such a manner that they can be pivoted transversely with respect to the housing axis, wherein at least one body comprises a connection portion for the optical device and that the second body is allocated a further locking device. The first body is formed as a joint ball and the second body is formed as a barrel-shaped or cylinder-shaped part.

The joint ball is arranged within the barrel and can pivot with respect thereto about a continuous shaft (cf. FIG. 1).

This construction and the structure of the parts are complex and costly to produce and assemble. In addition, the movement or adjustment path is restricted by the barrel shape of the first body.

### SUMMARY OF THE INVENTION

An object of the present invention is to provide a tripod head which has greater adjustment options, such as over the aforementioned EP 0 349 948 A1, and can be produced and assembled more simply.

In an embodiment of the present invention, a tripod head for receiving an optical device comprises a cylinder-shaped housing which comprises a connection device for a tripod at one end, and comprises a plane-symmetrical body which is arranged such that it can pivot in the housing, and further comprises a locking device for clamping the plane-symmetrical body, wherein the plane-symmetrical body is a hollow and two-part joint ball whose cavity forms an installation space and a guide for a pivoting part.

By virtue of the fact that the plane-symmetrical body is a hollow and two-part joint ball whose cavity forms an installation space and a guide for a pivoting part, the extent of the adjustment path is greater than in the case of the known barrel shape on account of the ball shape. Moreover, the cavity can be used in a space-saving manner as an installation space, thus making the entire tripod head smaller and lightweight. In addition, production of the joint ball itself is simplified by the two-part arrangement, the assembly being simpler on the whole. Previously, such joint balls were milled at great cost from solid material. By means of the invention, cast parts can now be used which only have to undergo finishing work. Moreover, this configuration permits simplified assembly, e.g. in comparison with EP 0 349 948 A1, in which the assembly must take place completely within the housing in a gradual manner. This not only makes initial assembly but also repair more difficult.

In the present case, the term “two-part joint ball” is intended to mean that two ball half shells are present.

If the joint ball comprises an opening, through which the pivoting part engages outwardly, the pivoting part can be used for connection to the optical device and at the same time increase or complement the extent of the pivoting movement of the joint ball, in particular if the pivot axis of the pivoting part is arranged more closely to the opening in the housing than the pivot axis of the joint ball.

In a preferred embodiment, the pivoting part comprises a slotted ring.

In a preferred embodiment, the slotted ring is arranged in the guide, so that the pivoting part is guided via the ring.

If a second locking device engages through the slotted ring, in particular the slot, in order to lock the pivoting part, which is movable in the joint ball, with respect to the joint ball, a compact and simple structure is achieved.

The first locking device can comprise in each case at least two members which are each provided with an inclined surface, wherein the inclined surfaces are arranged such that they lie one on top of the other and can be displaced transversely with respect to one another, in order to displace one of the members against the joint ball in order to achieve the clamping effect, if an adjusting device which is in engagement with the other member displaces the other member transversely with respect to the first-mentioned member. Secure and at the same time simple locking is thus achieved.

The second locking device can similarly comprise two members, which are adjustable with respect to one another at a spaced interval by means of an adjusting device, in order to achieve a clamping effect on the pivoting part.

Further features and advantages of the invention will be apparent from the description hereinafter of an exemplified embodiment with reference to the drawings.

### BRIEF DESCRIPTION OF THE DRAWINGS

FIG. 1 shows a perspective view of a tripod head in accordance with the invention;

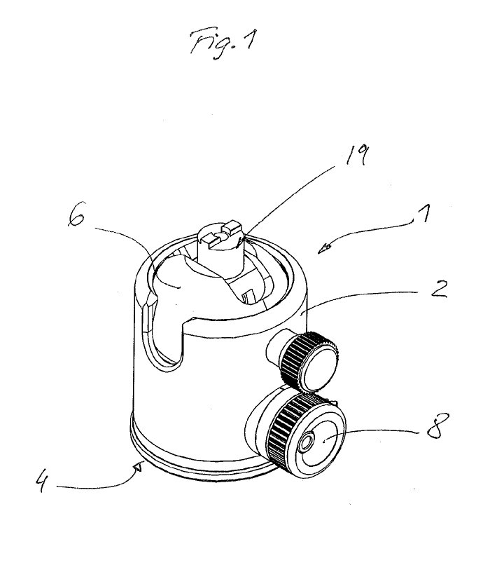

FIG. 2 shows a plan view of the tripod head of FIG. 1;

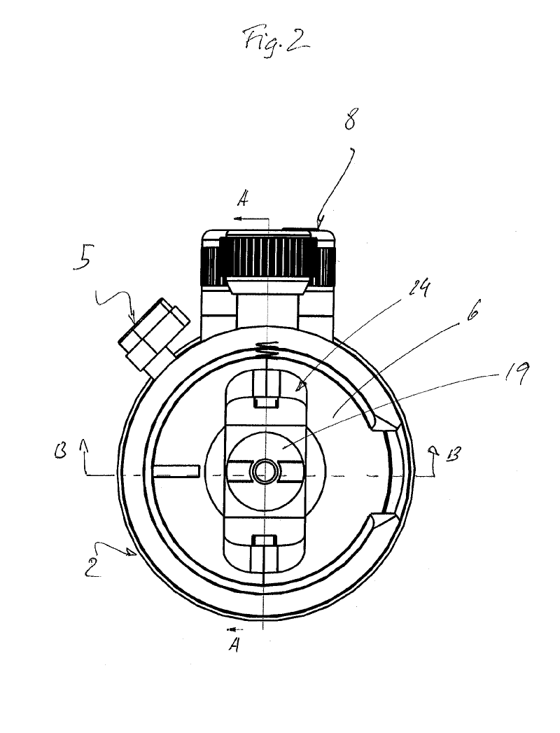

FIG. 3 shows a longitudinal sectional view of the tripod head of FIG. 2 along line A-A;

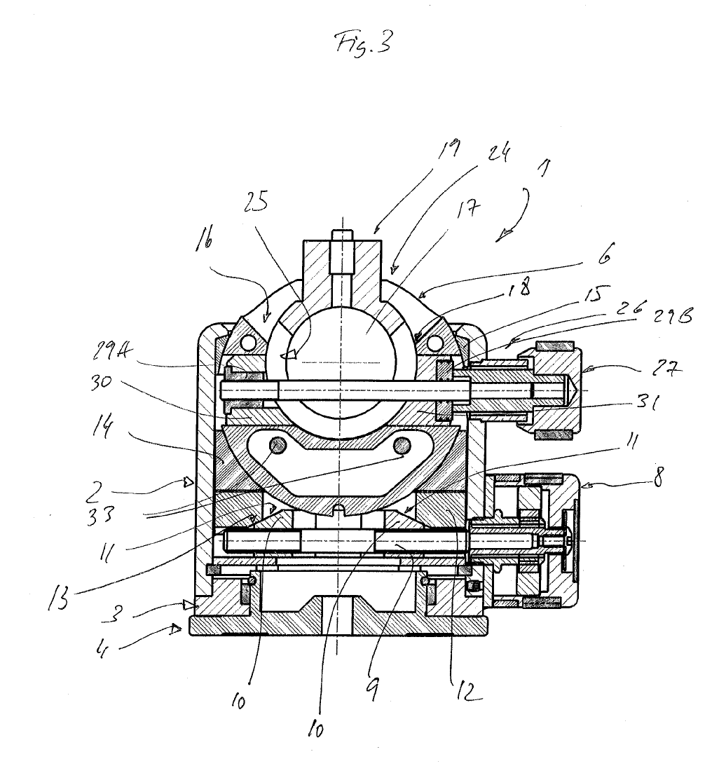

FIG. 4 shows a longitudinal sectional view of the tripod head of FIG. 2 along line B-B; and

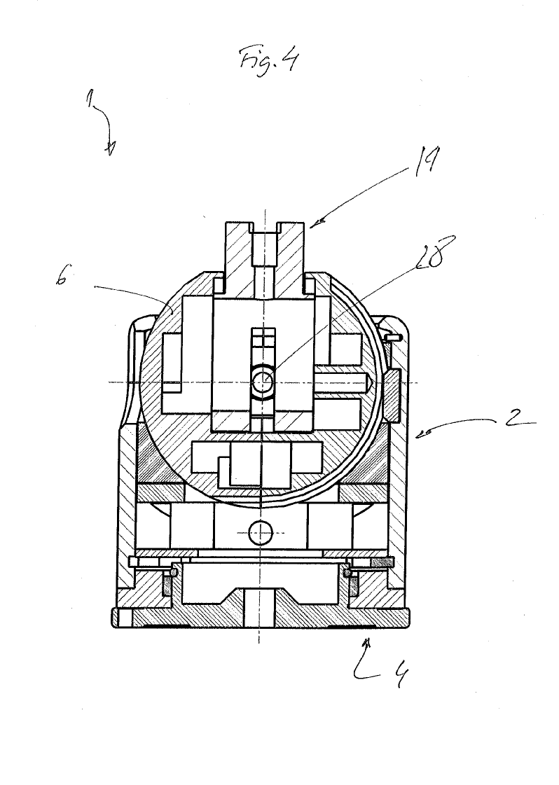

FIG. 5 shows a perspective exploded view of the joint ball and the pivoting part of FIG. 1.

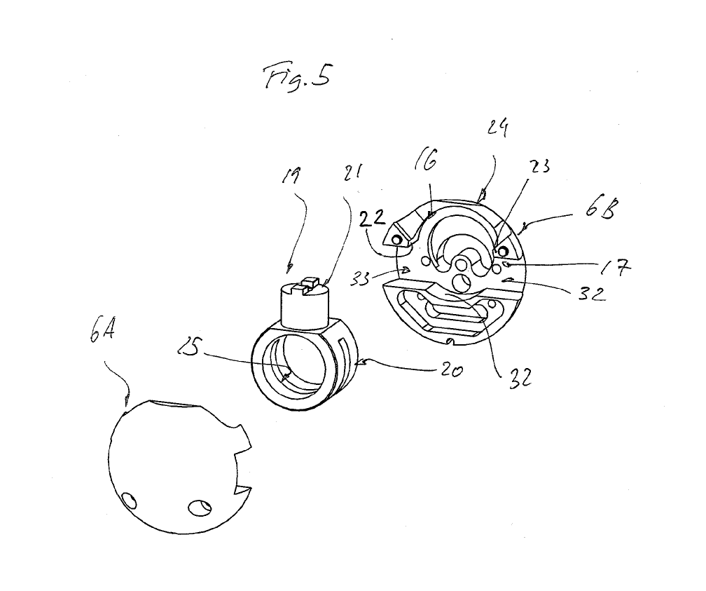

The figures illustrate a tripod head, designated in its entirety by the reference numeral 1, for a camera.

The tripod head comprises a cylindrical housing 2 which is mounted on a panoramic turntable 4 by means of a sliding bearing 3.

A threaded bore for fastening to a tripod is provided in the turntable 4.

The panoramic turntable 4 can be locked or released by means of an adjusting knob 5.

Also provided in the housing 2 is a pivotable joint ball 6 which can be clamped against the housing 2 for fixing purposes by means of a locking device 7. The locking device 7 is actuated by means of a rotary knob 8 which is arranged externally on the housing periphery.

The locking device 7 comprises a threaded spindle 9 which is actuated by means of the rotary knob 8 and on which two threaded blocks 10 are arranged which each comprise an outwardly directed inclined surface 11. Resting on the inclined surfaces 11 is a ring 12 which is likewise configured with a correspondingly oriented inclined surface 13 and which, in turn, acts upon a bearing ring 14 which lies thereabove and on which the joint ball 6 rests in a sliding manner.

By rotating the spindle 9, the threaded blocks 10 are displaced relative to one another on the spindle, so that their inclined surfaces 11 interact with the inclined surface 13 of the ring 12, in order to raise or lower the ring, whereby depending upon the movement the bearing ring 14 pushing the joint ball 6 against a further fixed bearing ring 15 above the joint ball 6, in order to lock the joint ball 6 or to release it for pivoting.

The joint ball 6 is hollow and formed in two parts (6A, 6B), wherein its cavity 16 forms an installation space 17 and a guide 18 for a pivoting part 19, to which the camera is fastened. The two parts (6A, 6B) are formed in the manner of ball half shells.

The two parts 6A, 6B are substantially identical but are formed in a mirror-inverted manner and are connected to one another by means of a screw-connection 33.

The pivoting part 19 comprises a slotted ring 20 and a cylindrical connection part 21 fastened thereto for connection to the camera.

The ring 20 lies in a pivotable manner in the guide 18 which is formed from a curved, partly cylinder-shaped aperture 32 and two lugs 22 and 23.

Between the two lugs 22, 23, the joint ball 6 comprises an opening 24, through which the pivoting part or connection part 21 engages outwardly.

A second locking device 26 engages through the slot 25 of the slotted ring 20 in order to fix the pivoting part 19, which is movable in the joint ball 6, with respect to the joint ball 6.

The locking device 26 comprises a threaded spindle 28 which is actuated by means of a rotary knob 27 and engages through the slot 25 and on which two threaded blocks 29A, B are arranged which each act upon a bearing block 30, 31. The bearing blocks 30, 31 are received in corresponding apertures 32, 33 of the joint ball 6.

By rotating the spindle 28, the threaded blocks 29A, B are displaced relative to one another on the spindle, so that they press and thus fix the bearing blocks 30, 31 against, or remove and release them from, the ring 20.

The threaded spindle 28 is located precisely in the pivot axis S of the joint ball 6, i.e. it is pivoted about the threaded spindle 28 in a direction transverse to the pivoting direction of the pivoting part 19.

1. Tripod head for receiving an optical device, comprising a cylinder-shaped housing which comprises a connection device for a tripod at one end, and comprising a plane-symmetrical body which is arranged such that it can pivot in the housing, and comprising a locking device for clamping the plane-symmetrical body, wherein the plane-symmetrical body is a hollow and two-part joint ball whose cavity forms an installation space and a guide for a pivoting part.

2. Tripod head as claimed in claim 1, wherein the joint ball comprises an opening, through which the pivoting part engages outwardly.

3. Tripod head as claimed in claim 1, wherein the pivoting part comprises a slotted ring.

4. Tripod head as claimed in claim 3, wherein the slotted ring is arranged in the guide.

5. Tripod head as claimed in claim 3, wherein a second locking device engages through the slotted ring in order to lock the pivoting part, which is movable in the joint ball, with respect to the joint ball.

6. Tripod head as claimed in claim 1, wherein the pivoting part comprises a connection portion.

7. Tripod head as claimed in claim 1, wherein the first locking device comprises in each case at least two members which are each provided with an inclined surface, wherein the inclined surfaces are arranged such that they lie one on top of the other and can be displaced transversely with respect to one another, in order to displace one of the members against the joint ball in order to achieve the clamping effect, if an adjusting device which is in engagement with the other member displaces the other member transversely with respect to the first-mentioned member.

8. Tripod head as claimed in claim 5, wherein the second locking device comprises two members, which can be displaced with respect to one another at a spaced interval by means of an adjusting device, in order to achieve a clamping effect on the pivoting part.

9. Tripod head as claimed in claim 4, wherein a second locking device engages through the slotted ring in order to lock the pivoting part, which is movable in the joint ball, with respect to the joint ball.

10. Tripod head as claimed in claim 2, wherein the pivoting part comprises a slotted ring.

11. Tripod head as claimed in claim 10, wherein the slotted ring is arranged in the guide.

12. Tripod head as claimed in claim 10, wherein a second locking device engages through the slotted ring in order to lock the pivoting part, which is movable in the joint ball, with respect to the joint ball.

13. Tripod head as claimed in claim 11, wherein a second locking device engages through the slotted ring in order to lock the pivoting part, which is movable in the joint ball, with respect to the joint ball.

14. Tripod head as claimed in claim 13, wherein the pivoting part comprises a connection portion.

15. Tripod head as claimed in claim 14, wherein the first locking device comprises in each case at least two members which are each provided with an inclined surface, wherein the inclined surfaces are arranged such that they lie one on top of the other and can be displaced transversely with respect to one another, in order to displace one of the members against the joint ball in order to achieve the clamping effect, if an adjusting device which is in engagement with the other member displaces the other member transversely with respect to the first-mentioned member.

16. Tripod head as claimed in claim 15, wherein the second locking device comprises two members, which can be displaced with respect to one another at a spaced interval by means of an adjusting device, in order to achieve a clamping effect on the pivoting part.

17. Tripod head as claimed in claim 2, wherein the pivoting part comprises a connection portion.

18. Tripod head as claimed in claim 2, wherein the first locking device comprises in each case at least two members which are each provided with an inclined surface, wherein the inclined surfaces are arranged such that they lie one on top of the other and can be displaced transversely with respect to one another, in order to displace one of the members against the joint ball in order to achieve the clamping effect, if an adjusting device which is in engagement with the other member displaces the other member transversely with respect to the first-mentioned member.

19. Tripod head as claimed in claim 9, wherein the second locking device comprises two members, which can be displaced with respect to one another at a spaced interval by means of an adjusting device, in order to achieve a clamping effect on the pivoting part.

20. Tripod head as claimed in claim 12, wherein the second locking device comprises two members, which can be displaced with respect to one another at a spaced interval by means of an adjusting device, in order to achieve a clamping effect on the pivoting part.
